(19) United States
(12) Patent Application Publication
(10) Pub. No.: US 2024/0338187 A1
(43) Pub. Date: Oct. 10, 2024

(54) METHOD AND APPARATUS FOR IMPLEMENTING CONDITIONAL COMPILATION, DEVICE AND STORAGE MEDIUM

(71) Applicant: Beijing Bytedance Network Technology Co., Ltd., Beijing (CN)

(72) Inventor: Fengkai LIU, Beijing (CN)

(21) Appl. No.: 18/282,743

(22) PCT Filed: Mar. 1, 2022
(86) PCT No.: PCT/CN2022/078554

§ 371 Date: Jun. 6, 2024

(30) Foreign Application Priority Data
Mar. 24, 2021 (CN) 202110315401.6

(51) Int. Cl. G06F 8/41

(52) U.S. Cl. CPC G06F 8/443

(57) ABSTRACT

Embodiments of the present disclosure relate to a method and apparatus for implementing conditional compilation, a device and a storage medium. The method includes: compiling a Dart code of a project; acquiring information on an import condition in the import sentence in response to compiling the import sentence for importing a non-local library file; searching for an assigned value for the import condition from pre-obtained assigned values for conditions in the Dart code; and importing, in response to the assigned value for the import condition according with a preset condition, the non-local library file pointed in response to the import condition according with the preset condition into the Dart code for compilation, implementing the conditional compilation based on a Dart programming language. During Dart compilation, the non-local library file may be imported for compilation, thereby improving the flexibility of Dart programming and reducing the application limitation of Dart technology.

### CROSS-REFERENCE TO RELATED APPLICATIONS

The present application claims priority to Chinese Patent Application No. 202110315401.6, filed on Mar. 24, 2021 and titled “METHOD AND APPARATUS FOR IMPLEMENTING CONDITIONAL COMPILATION, AND DEVICE AND STORAGE MEDIUM”, which is incorporated herein by reference in its entirety.

### TECHNICAL FIELD

Embodiments of the present disclosure relate to the field of computer technologies, and more particularly, to a method and apparatus for implementing conditional compilation, a device and a storage medium.

### BACKGROUND

In related technologies, Dart is a commonly used computer programming language. In the course of compiling Dart codes, a Dart compiler can only detect and determine a local library file involved in the codes, but fail to support conditional compilation, so a non-local library file cannot be introduced through the conditional compilation, which greatly limits the flexibility of Dart programming and the application of Dart technology.

### SUMMARY

In order to solve the above technical problems or at least partially solve the above technical problems, embodiments of the present disclosure provide a method and apparatus for implementing conditional compilation, a device and a storage medium.

In a first aspect of embodiments of the present disclosure, a method for implementing conditional compilation is provided. The method includes:
compiling a Dart code of a project, the Dart code including an import sentence for importing a non-local library file; acquiring information on an import condition in the import sentence in response to compiling the import sentence; searching for an assigned value for the import condition from pre-obtained assigned values for conditions in the Dart code; and importing, in response to the assigned value for the import condition according with a preset condition, the non-local library file pointed in response to the import condition according with the preset condition into the Dart code for compilation.

In an implementation, the acquiring information on an import condition in the import sentence includes:
acquiring an import condition that begins with a preset character string in the import sentence.

In an implementation, prior to searching for the assigned value for the import condition from the pre-obtained assigned values for conditions in the Dart code, the method includes:
reading the assigned values for the conditions in the Dart code from a pre-obtained configuration file of the project.

In an implementation, prior to searching for the assigned value for the import condition from the pre-obtained assigned values for the conditions in the Dart code, the method includes:
displaying a command input interface to a user; and acquiring the assigned values for the conditions in the Dart code configured by the user on the command input interface.

In an implementation, after acquiring the assigned values for the conditions in the Dart code configured by the user on the command input interface, the method further includes:
updating the assigned values for the conditions acquired from the command input interface to the configuration file of the object.

In a second aspect of embodiments of the present disclosure, a compiling apparatus is provided. The apparatus includes:
a compilation module, configured to compile a Dart code of a project, the Dart code including an import sentence for importing a non-local library file;
a first acquiring module, configured to acquire information on an import condition in the import sentence in response to compiling the import sentence;
a searching module, configured to search for an assigned value for the import condition from pre-obtained assigned values for conditions in the Dart code; and
an importing module, configured to, import, in response to the assigned value for the import condition according with a preset condition, the non-local library file pointed in response to the import condition according with the preset condition into the Dart code for compilation.

In an implementation, the first acquiring module may be configured to:
acquire an import condition that begins with a preset character string in the import sentence.

In an implementation, the compiling apparatus further includes:
a second acquiring module, configured to read the assigned values for the conditions in the Dart code from a pre-obtained configuration file of the project.

In an implementation, the compilation apparatus further includes:
a displaying module, configured to display a command input interface to a user; and
a third acquiring module, configured to acquire the assigned values for the conditions in the Dart code configured by the user on the command input interface.

In an implementation, the apparatus further includes:
a file managing module, configured to update the assigned values for the conditions acquired from the command input interface to the configuration file of the object.

In a third aspect of embodiments of the present disclosure, a computer device is provided. The computer device includes a memory and a processor, wherein the memory is configured to store a computer program therein, which, when executed by the processor, may implement the method according to the first aspect.

In a fourth aspect of embodiments of the present disclosure, a computer-reasonable storage medium is provided. The storage medium is configured to store a computer program therein, which, when executed by a processor, may implement the method according to the first aspect.

Compared with the prior art, the technical solutions provided by the embodiments of the present disclosure have the following advantages.

According to the embodiments, the method includes: compiling a Dart code of a project; acquiring information on an import condition in the import sentence in response to compiling the import sentence for importing a non-local library file; searching for an assigned value for the import condition from pre-obtained assigned values for conditions in the Dart code; and importing, in response to the assigned value for the import condition according with a preset condition, the non-local library file pointed in response to the import condition according with the preset condition into the Dart code for compilation, thereby implementing conditional compilation based on a DART programming language. Thus, during Dart compilation, the non-local library file may be imported for compilation, thereby improving the flexibility of Dart programming and reducing the application limitation of Dart technology.

### BRIEF DESCRIPTION OF DRAWINGS

The drawings herein are incorporated into the description and constitute a part of the description, show embodiments that are consistent with the present disclosure, and are used together with the description to explain the principles of the present disclosure.

To describe the embodiments of the present invention or the technical solutions in the prior art more clearly, the following briefly introduces the accompanying drawings required for describing the embodiments and the prior art. Apparently, a person of ordinary skill in the art may still derive other drawings from these accompanying drawings without creative efforts.

FIG. 1 is a flowchart of a method for implementing conditional compilation according to an embodiment of the present disclosure;

FIG. 2 is a flowchart of a method for acquiring assigned values for conditions in a Dart code according to an embodiment of the present disclosure;

FIG. 3 is a schematic diagram of a command input interface according to an embodiment of the present disclosure;

FIG. 4 is a schematic diagram of a compilation apparatus according to an embodiment of the present disclosure; and

FIG. 5 is a schematic structural diagram of a computer device in an embodiment of the present disclosure.

### DESCRIPTION OF EMBODIMENTS

In order to make the objectives, features and advantages of the present disclosure clearer, the following will further describe the schemes of the present disclosure. It should be noted that the embodiments in the present disclosure and the features in the embodiments can be combined with each other if there is no conflict.

Many specific details are set out in the following description to facilitate a full understanding of the present disclosure, but the present disclosure may be implemented in other ways different from those described herein. Obviously, the embodiments in the description are only some embodiments of the present disclosure, rather than all embodiments.

FIG. 1 is a flowchart of a method for implementing conditional compilation according to an embodiment of the present disclosure. The method may be executed by a Dart compiler. As shown in FIG. 1, the method according to the present embodiment includes the following steps.

Step 101, a Dart code of a project is compiled, the Dart code includes an import sentence for importing a non-local library file.

The project involved in the present embodiment may be understood as a certain function or several functions implemented on the basis of a Dart programming language. For ease of understanding, in the present embodiment, the project may be exemplarily understood as an application with certain functions.

The Dart code of the project refers to a set of sentences which is compiled on the basis of the Dart programming language and used to represent an implementation logic of the project.

Unlike related techniques, the Dart code of the project involved in the present embodiment may include an import sentence for importing a non-local library file. The import sentence may generally be a sentence that begins with an “import” character string, but is not limited to the “import” character string. This sentence includes a judgment on an import condition of the non-local library file, for example, an if sentence, but is not limited to this if sentence. For example, the following is an exemplary import sentence according to an embodiment of the present disclosure:
import ‘package:bd_hook_coverage/empty.dart’

if(condition.hooked)‘package:bd_hook_coverage/bd_hook_coverage.dart’.

As shown above, in a case that the Dart compiler compiles the “import” character string, it is determined that the import sentence for importing the non-local library file is compiled. At this time, in a case that an assigned value for a condition “condition.hooked” in the if sentence is true (that is, the assigned value accords with a preset condition), a non-local library file “package:bd_hook_coverage/bd_hook_coverage.dart” is imported into the current Dart code for compilation. In a case that the assigned value for “condition.hooked” is false (that is, the assigned value does not accord with the preset condition), a non-local library file “package:bd_hook_coverage/empty.dart” is imported into the current Dart code for compilation. Of course, this is only an example illustration, not a unique limitation for the import sentence involved in the embodiments of the present disclosure.

Step 102, information on an import condition in the import sentence is acquired in response to compiling the import sentence for importing the non-local library file.

In the present embodiment, the import condition in the import sentence involved in the present embodiment may be exemplarily understood as a sentence that begins or ends with a preset character string in the import sentence. For example, in the foregoing example, the “condition.hooked” in parentheses in the if sentence may be understood as an import condition that begins with a preset character string “condition.”. In a case that the Dart compiler compiles the “condition.” in the if sentence, the import condition “condition.hooked” is acquired from the if sentence according to the character string “condition.”. That is, in one implementation of the embodiments of the present disclosure, the method for acquiring the information on the import condition in the import sentence includes: acquiring an import condition that begins with a preset character string in the import sentence. Of course, the above content is only an example illustration, but not a unique limitation of the present disclosure.

Step 103, an assigned value for the import condition is search from pre-obtained assigned values for conditions in the Dart code.

The assigned values for the conditions in the Dart code may be declared in a macro condition of the Dart code. After acquiring the import condition in the import sentence based on Step 102, the assigned value for the import condition may be searched from the macro condition of the Dart code. For example, in a case that the macro condition of the Dart code includes declaration information “condition.hooked: true”, the condition “condition.hooked” in the if sentence in the preceding example accords with the preset condition (that is, the condition “condition.hooked” in the if sentence is true), and the non-local library file “package:bd_hook_coverage/bd_hook_coverage.dart” is imported into the Dart code for compilation. Conversely, in a case that the declaration information in the macro condition is “condition.hooked: false”, the condition “condition.hooked” in the if sentence in the preceding example does not accord with the preset condition (that is, the condition “condition.hooked” in the if sentence is false), and the non-local library file “package:bd_hook_coverage/empty.dart” is imported into the Dart code for compilation.

Steps 104, in response to the assigned value for the import condition according with a preset condition, the non-local library file pointed in response to the import condition according with the preset condition into the Dart code for compilation is imported.

According to the embodiments of the present disclosure, the method includes: compiling a Dart code of a project; acquiring information on an import condition in the import sentence in response to compiling the import sentence for importing a non-local library file; searching for an assigned value for the import condition from pre-obtained assigned values for conditions in the Dart code; and importing, in response to the assigned value for the import condition according with a preset condition, the non-local library file pointed in response to the import condition according with the preset condition into the Dart code for compilation, thereby implementing conditional compilation based on a DART programming language. Thus, during Dart compilation, the non-local library file may be imported for compilation, thereby improving the flexibility of Dart programming and reducing the application limitation of Dart technology.

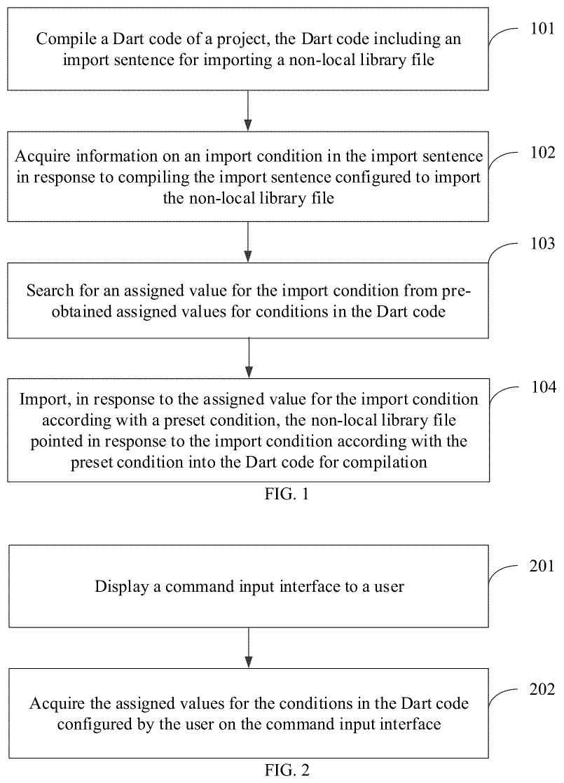

FIG. 2 is a flowchart of a method for acquiring assigned values for conditions in the Dart code according to an embodiment of the present disclosure. As shown in FIG. 2, prior to Step 103 of the above embodiment, the method may further include the following steps.

Step 201, a command input interface is displayed to a user.

Step 202, the assigned values for the conditions in the Dart code configured by a user on the command input interface are acquired.

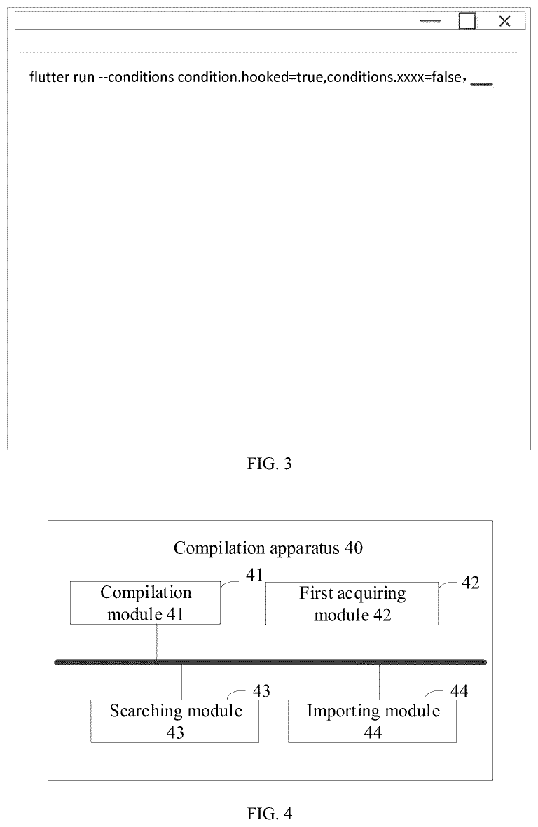

Exemplarily, FIG. 3 is a schematic diagram of a command input interface according to an embodiment of the present disclosure. The user may assign values to respective import conditions included in the Dart code on this command input interface. For example, a character string “flutter run-conditions” in FIG. 3 is used to indicate that the following character string is a declaration on the assigned value for the import condition in the Dart code, and a character string “condition.hooked=true” is used to indicate that an assigned value for an import condition “condition.hooked” is “true”. In a case that the Dart compiler compiles the import condition “condition.hooked”, a library file pointed in response to the assigned value for the “condition.hooked” being “true” is imported into the Dart code for compilation. A character string “conditions.xxxx=false” in FIG. 3 is used to indicate that an assigned value for an import condition “conditions.xxxx” is “false”. In a case that the Dart compiler compiles the import condition “condition.xxxx”, a library file pointed in response to the assigned value for the “condition.xxxx” being “false” is imported into the Dart code for compilation. Of course, this is only an example illustration in FIG. 3, but not the only limitation of the embodiments of the present disclosure.

Optionally, in a feasible implementation of the present embodiment, after acquiring the assigned values for the conditions in the Dart code from the command input interface, the assigned values for these conditions may also be updated to a configuration file of the project, so that data in the configuration file is always the latest data.

In the present embodiment, by displaying the command input interface to the user, the user may assign a value for the import condition in the Dart code on the command input interface, thereby improving the flexibility of the value assignment method for the import condition.

It is worth noting that the method in the above embodiment in FIG. 2 is only one of the methods (but not all methods) that may be used to acquire the assigned values for respective import conditions in the Dart code. In fact, in other embodiments, it is also possible to read the assigned values corresponding to the respective import conditions in the Dart code directly from the configuration file of the project corresponding to the Dart code (e.g., a “pubspec.yaml” file, but not limited to the “pubspec.yaml” file).

FIG. 4 is a schematic structural diagram of a compilation apparatus according to an embodiment of the present disclosure. The compilation apparatus may be exemplarily understood as the Dart compiler in the above embodiment, or some functional modules in the Dart compiler. As shown in FIG. 4, the compilation apparatus 40 includes:
a compilation module 41, configured to compile a Dart code of a project, the Dart code including an import sentence for importing a non-local library file;
a first acquiring module 42, configured to acquire information on an import condition in the import sentence in response to compiling to the import sentence;
a searching module 43, configured to search for an assigned value for the import condition from pre-obtained assigned values for conditions in the Dart code; and
an importing module 44, configured to, import, in response to the assigned value for the import condition according with a preset condition, the non-local library file pointed in response to the import condition according with the preset condition into the Dart code for compilation.

In an implementation, the first acquiring module 42 may be configured to:
acquire an import condition that begins with a preset character string in the import sentence.

In an implementation, the compilation apparatus further includes:
a second acquiring module, configured to read the assigned values for the conditions in the Dart code from a pre-obtained configuration file of the project.

In an implementation, the compilation apparatus further includes:
a displaying module, configured to display a command input interface to a user; and
a third acquiring module, configured to acquire the assigned values for the conditions in the Dart code configured by the user on the command input interface.

In an implementation, the apparatus further includes:
a file managing module, configured to update the assigned values for the conditions acquired from the command input interface to the configuration file of the object.

The apparatus according to the present embodiment is capable of performing the method in any of the method embodiments, which is performed similarly in terms of way and beneficial effects, and will not be repeated herein.

An embodiment of the present disclosure further provides a computer device. The computer device includes a memory and a processor, wherein the memory is configured to store a computer program therein, which, when executed by the processor, may implement the method according to any embodiments in FIGS. 1 to 3.

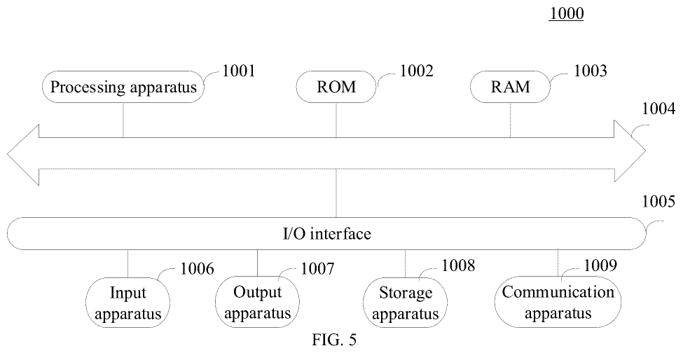

Exemplarily, FIG. 5 is a schematic structural diagram of a computer device in an embodiment of the present disclosure. Specifically referring to FIG. 5 below, FIG. 5 is a schematic structural diagram of a computer device 1000 in an embodiment of the present disclosure. The computer device 1000 in the embodiments of the present disclosure may include, but is not limited to, a laptop, a desktop computer or other device having certain computing and processing abilities. The computer device shown in FIG. 5 is only an example and should not impose any limitation on the functionality and scope of use in the embodiments of the present disclosure.

As shown in FIG. 5, the computer device 1000 may include a processing apparatus (e.g., a central processing unit, a graphics processing unit) 1001, which may perform various appropriate actions and processing according to a program stored in a read-only memory (ROM) 1002 or a program that is loaded into a random access memory (RAM) from a storage apparatus 1008. The RAM 1003 is further configured to store various programs and data required for the operations of the computer device 1000. The processing apparatus 1001, the ROM 1002 and the RAM 1003 are connected to each other via a bus 1004. The input/output (I/O) interface 1005 is also connected to the bus 1004.

Typically, the following apparatuses may be connected to the I/O interface 1005: an input apparatus 1006 including a touch screen, a touchpad, a keyboard, a mouse, etc.; an output apparatus 1007 including a liquid crystal display (LCD), a speaker, a vibrator, etc.; a storage apparatus 1008 including a magnetic tape, a hard disk, etc.; and a communication apparatus 1009. The communication apparatus 1009 may allow the computer device 1000 and other devices to communicate in a wireless or wired manner to exchange data. Although FIG. 5 shows the computer device 1000 equipped with various apparatuses, it should be understood that not all the apparatuses shown need to be implemented or equipped. More or fewer apparatuses may be implemented or equipped alternatively.

In particular, according to the embodiments of the present disclosure, the process described above with reference to the flowchart may be implemented as a computer software program. For example, an embodiment of the present disclosure includes a computer program product. The computer program product includes a computer program loaded on a non-transient computer-readable medium, the computer program including a program code configured to perform the method shown in the flowchart. In such an embodiment, the computer program may be downloaded and installed from the network via the communication apparatus 1009, or installed from the storage apparatus 1008, or installed from the ROM 1002. In response to this computer program being executed by the processing apparatus 1001, the above functions as defined in the method of the embodiments of the present disclosure are performed.

It should be noted that the computer-readable medium described in the present disclosure may be a computer-readable signal medium or a computer-readable storage medium, or any combination of the two. The computer-readable storage medium may be, for example, but not limited to electrical, magnetic, optical, electromagnetic, infrared, or semiconductor systems, apparatuses or devices, or any combination thereof. More specific examples of the computer-readable storage medium include, but are not limited to: an electric connector having one or more leads, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination thereof. In the present disclosure, the computer-readable storage medium may be any tangible medium including or storing a program, which may be used by an instruction execution system, apparatus or device or used in combination therewith. In the present disclosure, the computer-readable signal medium may include a data signal included in a baseband or propagated as part of a carrier which carries computer-readable program codes. This propagated data signal may take many forms, including but not limited to, an electromagnetic signal, an optical signal, or any suitable combination of the foregoing. The computer-readable signal medium may also be any computer-readable medium other than the computer-readable storage medium. The computer-readable signal medium may send, propagate, or transmit programs used by or used in combination with the instruction execution system, apparatus or device. The program codes contained in the computer-readable medium may be transmitted using any appropriate medium, including but not limited to: a wire, an optical cable, an RF (radio frequency), etc., or any suitable combination thereof.

The computer-readable medium may be contained in the computer device, also may also exist alone while not be assembled into the computer device.

The computer-readable medium is configured to carry one or more programs, which, when executed by the computer device, causes the computer device to perform: compiling a Dart code of a project, the Dart code including an import sentence for importing a non-local library file; acquiring information on an import condition in the import sentence in response to compiling the import sentence; searching for an assigned value for the import condition from pre-obtained assigned values for conditions in the Dart code; and importing, in response to the assigned value for the import condition according with a preset condition, the non-local library file pointed in response to the import condition according with the preset condition into the Dart code for compilation.

One or more programming languages or a combination thereof may be used to compile computer program codes for performing the operations of the present disclosure, wherein the programming languages include, but are not limited to, object-oriented programming languages, such as Dart, Java, Smalltalk and C++, as well as conventional procedural programming languages, such as the “C” language or similar programming languages. The program codes may be executed entirely on a user computer, partly on a user computer, as a stand-alone software package, partly on the user computer and partly on a remote computer, or entirely on a remote computer or a server. In a case of the remote computer, the remote computer may be connected to the user computer through any type of network (including a local area network (LAN) or wide area network (WAN)), or may be connected to an external computer (e.g., using an Internet service provider via the Internet).

The flowchart and block diagram in the accompanying drawings illustrate the system architecture, functions and operations of the system, method and computer program product that may be implemented in accordance with various embodiments of the present disclosure. At this point, each block in the flowchart or block diagram may represent a module, a program segment, or part of code, wherein the module, program segment, or part of code contains one or more executable instructions for implementing a specified logical function. It should also be noted that in some alternative implementations, the functions indicated in the block may also occur in a different order than those indicated in the drawings. For example, two blocks represented consecutively may actually be performed in substantially parallel, and they may sometimes be performed in a reverse order, depending on the functionality involved. It should also be noted that each block in the block diagram and/or flowchart, and the combination of block in the block diagram and/or flowchart, may be implemented by a dedicated hardware-based system for performing a specified function or operation, or may be implemented by a combination of dedicated hardware and computer instructions.

The units involved in the embodiments of the present disclosure may be implemented by means of software, or by means of hardware. Here, the names of the units do not in some cases constitute a limitation for the units themselves.

The functions described herein may be performed at least in part by one or more hardware logical components. For example, without limitation, the demonstrated types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium which may include or store a program for use by or in combination with the instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses or devices, or any combination thereof. More specific examples of the machine-readable storage medium may include: an electric connector having one or more leads, a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination thereof.

An embodiment of the present disclosure further provides a computer-readable storage medium. The storage medium is configured to store a computer program therein. The computer program, when executed by a processor, may implement the method according to any embodiment in FIG. 1 to FIG. 3, which may be performed similarly in terms of way and beneficial effects, and will not be repeated here.

It should be noted that, as used herein, relation terms such as “first” and “second” are used merely to distinguish a subject or an operation from another subject or another operation not to imply any substantial relation or order between these subjects or operations. Moreover, terms “include”, “contain” or any variation thereof are intended to cover a nonexclusive containing, such that a process, a method, an item or a device containing a series of elements not only includes these elements, but also includes other elements that are not set forth specifically, or also includes an inherent element of such a process, method, item or device. Without further limitation, an element defined by a phrase “include a . . . ” does not mean that other elements are excluded from the process, method, item or device including the same element.

The foregoing is only a specific implementation of the present disclosure, such that those skilled in the art can understand or implement the present disclosure. A variety of modifications of these embodiments will be obvious to those skilled in the art, and the general principles defined herein may be implemented in other embodiments without departing from the spirit or scope of the present disclosure. Accordingly, the present disclosure will not be limited to these embodiments shown herein, but will conform to the widest range consistent with the principles and novel features disclosed herein.

1-12. (canceled)

13. A method for implementing conditional compilation, comprising:
compiling a Dart code of a project, the Dart code comprising an import sentence for importing a non-local library file;
acquiring information on an import condition in the import sentence in response to compiling the import sentence;
searching for an assigned value for the import condition from pre-obtained assigned values for conditions in the Dart code; and
importing, in response to the assigned value for the import condition according with a preset condition, the non-local library file pointed in response to the import condition according with the preset condition into the Dart code for compilation.

14. The method according to claim 13, said acquiring information on an import condition in the import sentence comprises:
acquiring an import condition that begins with a preset character string in the import sentence.

15. The method according to claim 13, further comprising, prior to said searching for the assigned value for the import condition from the pre-obtained assigned values for the conditions in the Dart code:
reading the assigned values for the conditions in the Dart code from a pre-obtained configuration file of the project.

16. The method according to claim 14, further comprising, prior to searching for the assigned value for the import condition from the pre-obtained assigned values for the conditions in the Dart code:
reading the assigned values for the conditions in the Dart code from a pre-obtained configuration file of the project.

17. The method according to claim 13, further comprising, prior to said searching for the assigned value for the import condition from the pre-obtained assigned values for the conditions in the Dart code:
displaying a command input interface to a user; and
acquiring the assigned values for the conditions in the Dart code configured by the user on the command input interface.

18. The method according to claim 14, further comprising, prior to said searching for the assigned value for the import condition from the pre-obtained assigned values for the conditions in the Dart code:
displaying a command input interface to a user; and
acquiring the assigned values for the conditions in the Dart code configured by the user on the command input interface.

19. The method according to claim 17, further comprising, subsequent to said acquiring the assigned values for the conditions in the Dart code configured by the user on the command input interface:
updating the assigned values for the conditions acquired from the command input interface to the configuration file of the object.

20. The method according to claim 18, further comprising, subsequent to said acquiring the assigned values for the conditions in the Dart code configured by the user on the command input interface:
updating the assigned values for the conditions acquired from the command input interface to the configuration file of the object.

21. A computer device, comprising:
a processor and a memory, the memory being configured to store a computer program therein, the computer program, when executed by the processor, causing the processor to:
compile a Dart code of a project, the Dart code comprising an import sentence for importing a non-local library file;
acquire information on an import condition in the import sentence in response to compiling the import sentence;
search for an assigned value for the import condition from pre-obtained assigned values for conditions in the Dart code; and
import, in response to the assigned value for the import condition according with a preset condition, the non-local library file pointed in response to the import condition according with the preset condition into the Dart code for compilation.

22. The computer device according to claim 21, wherein the computer program, when executed by the processor, further causes the processor to:
acquire an import condition that begins with a preset character string in the import sentence.

23. The computer device according to claim 21, wherein the computer program, when executed by the processor, further causes the processor to, prior to searching for the assigned value for the import condition from the pre-obtained assigned values for the conditions in the Dart code:
read the assigned values for the conditions in the Dart code from a pre-obtained configuration file of the project.

24. The computer device according to claim 22, wherein the computer program, when executed by the processor, further causes the processor to, prior to searching for the assigned value for the import condition from the pre-obtained assigned values for the conditions in the Dart code:
read the assigned values for the conditions in the Dart code from a pre-obtained configuration file of the project.

25. The computer device according to claim 21, wherein the computer program, when executed by the processor, further causes the processor to, prior to searching for the assigned value for the import condition from the pre-obtained assigned values for the conditions in the Dart code:
display a command input interface to a user; and
acquire the assigned values for the conditions in the Dart code configured by the user on the command input interface.

26. The computer device according to claim 22, wherein the computer program, when executed by the processor, further causes the processor to, prior to searching for the assigned value for the import condition from the pre-obtained assigned values for the conditions in the Dart code:
display a command input interface to a user; and
acquire the assigned values for the conditions in the Dart code configured by the user on the command input interface.

27. The computer device according to claim 25, wherein the computer program, when executed by the processor, further causes the processor to, subsequent to said acquiring the assigned values for the conditions in the Dart code configured by the user on the command input interface:
update the assigned values for the conditions acquired from the command input interface to the configuration file of the object.

28. The computer device according to claim 26, wherein the computer program, when executed by the processor, further causes the processor to, subsequent to said acquiring the assigned values for the conditions in the Dart code configured by the user on the command input interface:
update the assigned values for the conditions acquired from the command input interface to the configuration file of the object.

29. A computer-readable storage medium, configured to store a computer program therein, the computer program, when executed by a processor, causing the processor to:
compile a Dart code of a project, the Dart code comprising an import sentence for importing a non-local library file;
acquire information on an import condition in the import sentence in response to compiling the import sentence;
search for an assigned value for the import condition from pre-obtained assigned values for conditions in the Dart code; and
import, in response to the assigned value for the import condition according with a preset condition, the non-local library file pointed in response to the import condition according with the preset condition into the Dart code for compilation.

30. The computer-readable storage medium according to claim 29, wherein the executable instruction, when executed by the processor, further causes the processor to:
acquire an import condition that begins with a preset character string in the import sentence.

31. The computer-readable storage medium according to claim 29, wherein the executable instruction, when executed by the processor, further causes the processor to, prior to searching for the assigned value for the import condition from the pre-obtained assigned values for the conditions in the Dart code:
read the assigned values for the conditions in the Dart code from a pre-obtained configuration file of the project.

32. The computer-readable storage medium according to claim 30, wherein the executable instruction, when executed by the processor, further causes the processor to, prior to searching for the assigned value for the import condition from the pre-obtained assigned values for the conditions in the Dart code:
read the assigned values for the conditions in the Dart code from a pre-obtained configuration file of the project.
